(19) United States
(12) Patent Application Publication
(10) Pub. No.: US 2008/0082661 A1
(43) Pub. Date: Apr. 3, 2008

(54) Method and Apparatus for Network Monitoring of Communications Networks

(75) Inventor: Mark A. Huber, Chester Springs, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/862,403

(22) Filed: Sep. 27, 2007

Related U.S. Application Data
(60) Provisional application No. 60/827,770, filed on Oct. 2, 2006.

(51) Int. Cl. G06F 15/173

(52) U.S. Cl. 709/224

(57) ABSTRACT

A network monitor autonomously determines the functional states of a plurality of network monitoring agents loaded on a plurality of network elements. The network monitor sends a query to each network monitoring agent. In response to a query, a network monitoring agent sends a reply back to the network monitor. The reply reports the functional state of the network monitoring agent, operational or non-operational. If the network monitor does not receive a reply back within a timeout interval, it determines that the functional state of the network monitoring agent is non-operational. In an advantageous embodiment, the network monitor autonomously attempts to restart a non-operational network monitoring agent.

This application claims the benefit of U.S. Provisional Application No. 60/827,770 filed Oct. 2, 2006, which is incorporated herein by reference.

### BACKGROUND OF THE INVENTION

The present invention relates generally to communications networks, and more particularly to network monitoring of communications networks.

Packet data networks may comprise a complex ensemble of network elements (hardware) and associated software. Examples of network elements include network equipment, such as servers, routers, and switches. Other examples include end-user devices, such as personal computers, Voice-Over-IP phones, and cell phones. In a network, software may comprise multiple tiers. Software well known to end-users are end-user applications, such as word processing and database management, and operating systems, such as Windows and Unix. Hidden from most end-users is the network operations software required for a network to function. Network operations software controls the critical functions of operation, administration, maintenance, and provisioning (OAM&P).

As packet data networks have grown increasingly pervasive, and as end-users have grown increasingly dependent on them, network reliability has become a crucial factor. One class of network operations software monitors performance and faults in the network. Network performance is a function of many parameters, such as central processing unit (CPU) utilization and available memory in a server, and traffic congestion in a router or switch. Network faults include both hardware failures, such as an inoperative router, and software failures, such as a non-responsive (“hung”) operating system process on a server. Network monitoring systems, which may include hardware probes in addition to network monitoring software, continuously monitor the network, to alert network administrators to faults (for example, failure of a router) or to problems before they become critical (for example, high CPU usage on a server). Network monitoring systems may be passive or active. A passive system, for example, may trigger a flashing red alarm on a monitoring board, or send an e-mail alert to a technician. An active system has more capabilities. For example, it may power down a server before it overheats, route traffic away from a router before it becomes overloaded, or restart a non-responsive process.

In commonly deployed network monitoring systems, network monitoring agents reside on network elements. A network monitoring agent is a software element which monitors parameters in the network element. Network monitoring agents are controlled by another software element, the network monitor. Various configurations of network monitoring systems are deployed. In some network monitoring systems, for example, a single network monitor residing on a single server controls the network monitoring agents. The network monitor also collects and processes data (values of parameters) transmitted from the network monitoring agents. Since a network monitoring system is a critical component of a packet data network, proper functioning of the network monitoring system itself is crucial. This is especially true of networks deployed for critical functions such as financial transactions and medical procedures. Some network monitoring systems give no indication of whether they are functioning properly or not. For example, the first indicator of a problem that the network administrator may note is that there have been no recent service updates. The network administrator may need to manually log on to the network monitoring system, diagnose it, and manually reboot some processes. A network monitoring system which monitors its own operation and attempts to autonomously correct its own faults would be advantageous.

### BRIEF SUMMARY OF THE INVENTION

A network monitor autonomously determines the functional states of a plurality of network monitoring agents loaded on a plurality of network elements. The network monitor sends a query to each network monitoring agent. In response to a query, a network monitoring agent sends a reply back to the network monitor. The reply reports the functional state of the network monitoring agent, operational or non-operational. If the network monitor does not receive a reply back within a timeout interval, it determines that the functional state of the network monitoring agent is non-operational. In an advantageous embodiment, the network monitor autonomously attempts to restart a non-operational network monitoring agent.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a packet data network;

FIG. 2 shows a functional block diagram of a network monitoring system;

FIG. 3A and FIG. 3B show a high-level flowchart of a process for monitoring network monitoring agents;

FIG. 4A and FIG. 4B show a flowchart of a specific implementation of a process for monitoring network monitoring agents;

FIG. 5 shows a flowchart of the GETSERVERS( ) routine, which extracts names of servers from a database;

FIG. 6A and FIG. 6B show a flowchart of the EXCLUDEPING( ) routine, which generates a list of servers which are not tested with an IP ping;

FIG. 7A and FIG. 7B show a flowchart of the CHECKPING( ) routine, which performs an IP ping test on servers;

FIG. 8A-FIG. 8D show a flowchart of the CHECKAWSERVICES( ) routine, which tests the operation of network monitoring agents;

FIG. 9 shows a flowchart of the RESTART( ) routine, which attempts to restart non-operational network monitoring agents;

FIG. 10 shows a high-level schematic of a network monitor implemented on a computer; and,

FIG. 11 shows a high-level schematic of a supervisory system.

### DETAILED DESCRIPTION

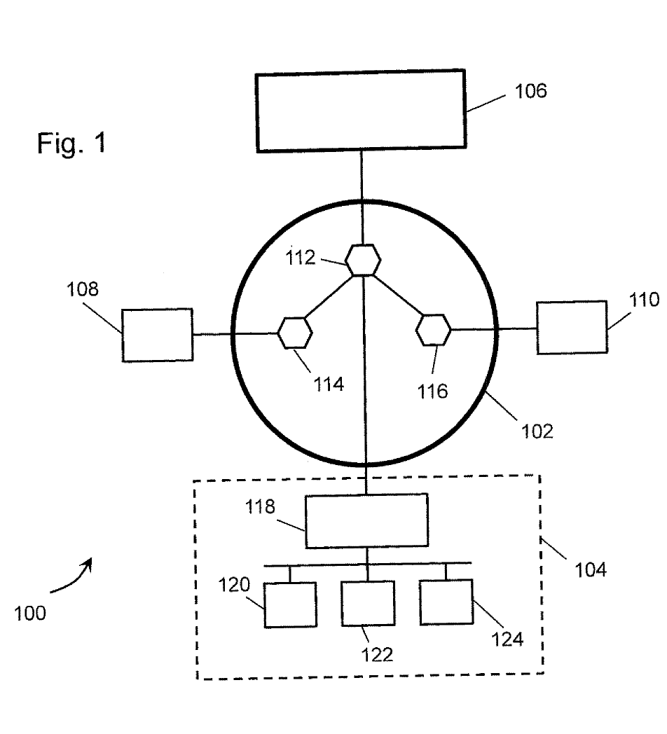

FIG. 1 shows a high-level schematic of a generic packet data network 100 comprising a wide-area network (WAN) 102 and a local-area network (LAN) 104. Shown in the figure are network elements 106-124. Herein, network element refers to hardware. Network elements 106-110, for example, may represent end-user equipment such as personal computers or workstations. Network elements 112-116, for example, may represent network equipment such as routers and switches. Network element 118, for example, may represent an instrument controller. Herein, a network element may comprise a system. Network elements 120-124, for example, may represent medical systems such as a C-arm X-Ray system, a Magnetic Resonance Imaging system, or a computer-controlled robotic surgical arm. Network elements transmit data to other network elements via data communications links.

In commonly deployed network monitoring systems, network monitoring agents reside on network elements. A network monitoring agent is a software element which monitors parameters in the network element. Herein, software resides in a network element if the software is loaded on the network element. Herein, if software resides in a network element, the software is associated with the network element, and the network element is associated with the software. A network monitoring agent may monitor both hardware and associated software residing on hardware. Examples are discussed below. Network monitoring agents are controlled by another software element, the network monitor. The network monitor also collects and processes data (values of parameters) transmitted from the network monitoring agents. Various configurations of network monitoring systems are deployed. In one example, a single network monitor residing on a single server controls the network monitoring agents in the network. In another example, a set of network monitors may be distributed among a set of servers.

The parameters of interest are selected by the network administrator from the set of parameters that a specific network element is capable of reporting. Herein, a network administrator is any user with access permission to perform the function of interest. Examples of parameters of interest include the following. For an end-user application, such as an image processing and display application for medical imaging, parameters of interest include, for example, the on/off status (whether it is running or not) of the application and the execution time. For an operating system, such as Windows or Unix, parameters of interest include, for example, CPU usage management, memory allocation management, and network interface management. For equipment, such as power supplies, and medical systems, such as a C-arm X-Ray system, parameters of interest include, for example, chassis temperature and mechanical failure.

Network monitoring agents commonly run on a high-level operating system such as Windows or Unix. Some network elements do not support high-level operating systems. Examples of these network elements include some routers, switches, and power supplies. In some instances, however, these network elements may be indirectly monitored by a network monitoring agent. Parameters of interest in some network elements are reported by low-level Management Information Bases (MIBs) to a network management system via SNMP (Simplified Network Management Protocol). The network management system runs on a high-level operating system, such as Windows or Unix, which supports the network monitoring agent. An important category of parameters are SNMP traps which report critical conditions such as temperature alarms in power supplies and high traffic congestion in routers.

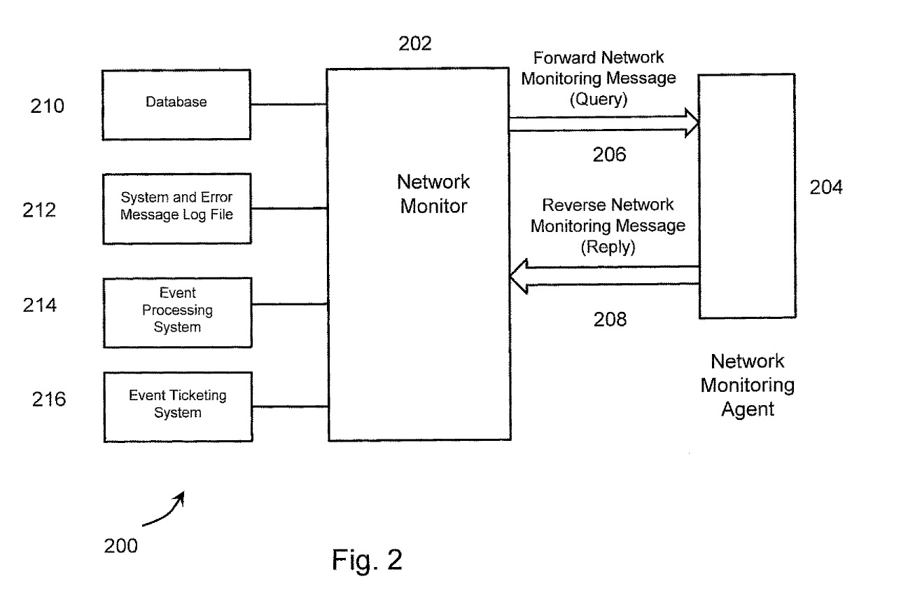

FIG. 2 shows a functional block diagram of an exemplary network monitoring system 200. Network monitor 202, which, in the embodiment shown, resides on a single server, communicates with a network monitoring agent 204, which resides on a network element. Herein, the server on which network monitor 202 resides is referred to as the network monitor server. In general, network monitor 202 communicates with a set of network monitoring agents residing on a set of network elements. To simplify the figure, only one network monitoring agent is shown. Network monitor 202 and network monitoring agent 204 exchange network monitoring messages over data communications links. Forward network monitoring message 206 is a message sent from network monitor 202 to network monitoring agent 204. Reverse network monitoring message 208 is a message sent from network monitoring agent 204 to network monitor 202. Herein, a message is a group of data packets. Specific forward and reverse network monitoring messages are discussed below.

Network monitor 202 communicates with database 210, which maintains a list of network elements on which network monitoring agents reside. Database 210, for example, may be a structured query language (SQL) database. When network monitor 202 detects a network condition which triggers a system message or error message, it sends the system message or error message to an event processing system 214, which displays system and error messages on an event console. Herein, a system message is generated as a result of a system event Herein, an error message is generated as a result of an error event. Herein, an event is a condition which the operating system or network administrator specifies as worthy of special consideration. System and error messages are also saved to a log file 212. Some system and error messages are also transmitted to an event ticketing system 216, which, for example, sends an e-mail to a service technician. System messages report system conditions specified by the network administrator. Error messages report errors (faults) specified by the network administrator.

As discussed above, a network monitoring system monitors parameters in network elements and parameters in associated software residing on network elements. A system which monitors the network monitoring system itself is referred to herein as a monitor-the-monitor (MtM) system. A process for monitoring the network monitoring system itself is referred to herein as a MtM process. In an advantageous embodiment, the MtM process runs on a robust server. Processes running on the server are monitored by the operating system and other software applications running on the server. In an advantageous embodiment, the network monitor may run on a robust server, which, for example, may be the same robust server on which the MtM process runs. Network monitoring agents, however, run on a variety of network elements. In many instances, the network elements and associated software residing on the network elements are less robust. In prior-art network monitoring systems, the functional states of network monitoring agents are manually checked by a network administrator, often in response to an error message or alert. Herein, an alert is also referred to as an alert message. Functional states are further discussed below.

In an advantageous embodiment, the MtM process is an autonomous process which determines the functional states of network monitoring agents. An autonomous process is a process which does not require manual intervention by a network administrator. Herein, there are two values of a functional state, operational and non-operational. The criteria for operational and non-operational are specified by the network administrator. Herein, a network monitoring agent whose functional state is operational is referred to as an operational network monitoring agent. Herein, a network monitoring agent whose functional state is non-operational is referred to as a non-operational network monitoring agent. The criteria may be varied during different phases of the MtM process. For example, initially, a functional state of a network monitoring agent may be operational if it is running; otherwise, non-operational. As another example, a functional state of a network monitoring agent which is already running may be operational if it passes a self-test (ST), which may include a series of test segments; otherwise, non-operational. The self-tests are specified by the network administrator. Since functional states are dynamic, it is further advantageous for the MtM process to run continuously. For example, the MtM process may determine the functional states of network monitoring agents at specified times. Herein, autonomous processes performed at specified times include both processes which run at specified times of the day (for example, at 1 pm, 6 pm, and 2 am) and processes which run at periodic intervals (for example, every 15 minutes). Herein, intermittent means at specified times.

There are various processes for determining the functional state of a network monitoring agent. Referring to FIG. 2, in one exemplary process, network monitor 202 autonomously sends a forward network monitoring message 206 to network monitoring agent 204. In this instance, forward network monitoring message 206 is a query requesting network monitoring agent 204 to report its functional state. In response to the query, network monitoring agent 204 sends a reverse network monitoring message 208 to network monitor 202. In this instance, reverse network monitoring message 208 is a reply reporting the functional state of network monitoring agent 204. If the query and reply process operates successfully, network monitor 204 receives the reply from network monitoring agent 204. Herein, interrogating means sending a query.

The query and reply may vary in complexity. For example, the query may be similar to a simple IP ping, and the reply “alive” indicates that the network monitoring agent is running. In another example, the query may comprise a command for the network monitoring agent to execute a ST. The reply reports the results of the ST. If the network monitoring agent has successfully passed the ST, its functional state is operational; otherwise, non-operational. If the network monitoring agent has not successfully passed the ST, the reply may further report which test segments of the ST the network monitoring agent has failed.

In other instances, network monitor 202 sends a query to network monitoring agent 204, and network monitor 202 does not receive a reply from network monitoring agent 204 within a timeout interval. The timeout interval is referenced to a clock associated with network monitor 202. The timeout interval is measured from the time that network monitor 202 sends a query to network monitoring agent 204. The duration (length) of the timeout interval is a configurable parameter specified by the network administrator. Herein, if network monitor 202 sends a query to network monitoring agent 204, and if network monitor 202 does not receive a reply back from network monitoring agent 204 within a specified timeout interval, network monitor 202 determines that the functional state of network monitoring agent 204 is non-operational. Herein, to simplify the terminology, the phrase “to receive a reply” means to receive a reply within a specified timeout interval.

In prior-art network monitoring systems, a non-operational network monitoring agent is manually diagnosed and restarted by a network administrator, often in response to an error message or alert. This procedure may result in critical network elements and associated software not being monitored for extended periods of time. In an advantageous embodiment of an MtM process, the network monitor, upon determining that a network monitoring agent is non-operational, autonomously attempts to restart the network monitoring agent by sending a command to execute a process to restart the network monitoring agent. An example of an autonomous restart process is given below. To minimize the need for manual intervention, the network monitor issues a second restart command if the first restart attempt fails. If the second attempt fails, an error message or alert is issued. The MtM process may be configured to permit more than two failed restart attempts before issuing an error message or alert.

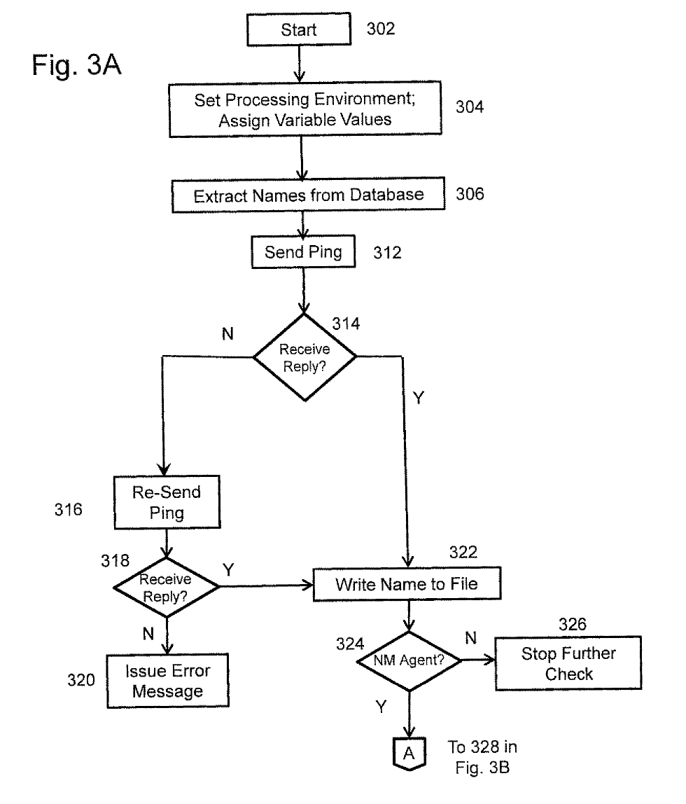

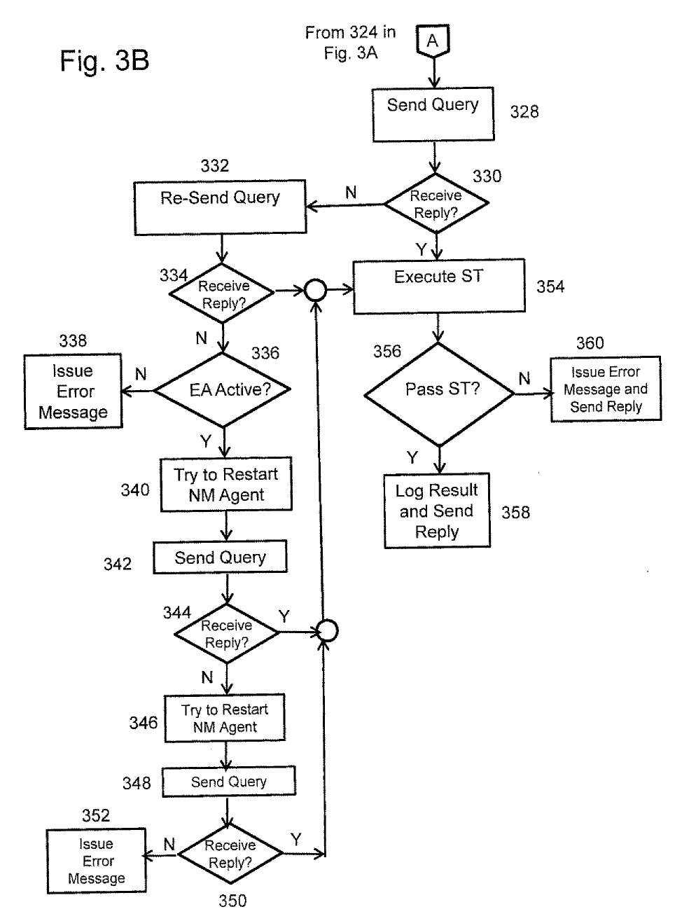

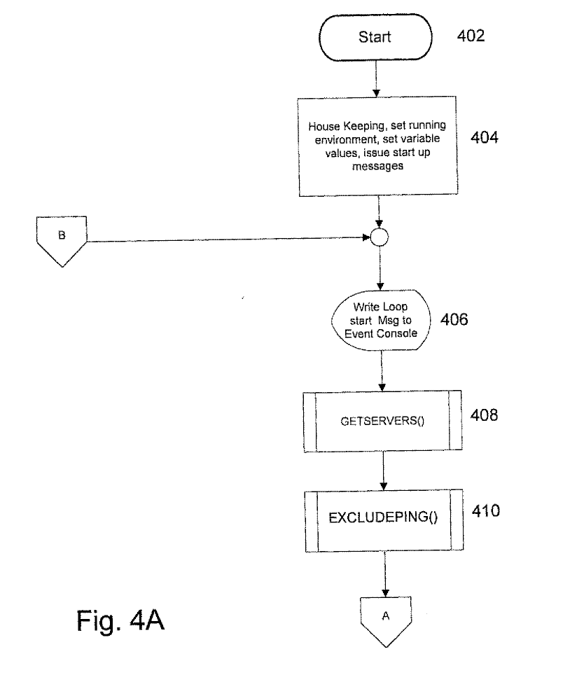

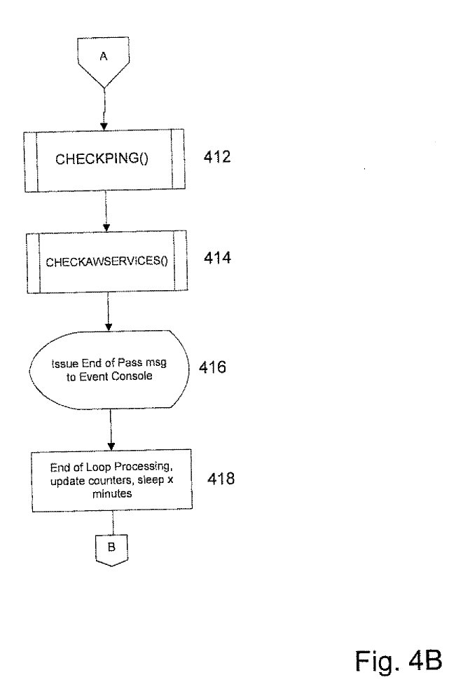

An embodiment of a MtM process is described with reference to the high-level flowchart shown in FIG. 3A and FIG. 3B. Another embodiment of an MtM process is described below with reference to more detailed flowcharts shown in FIG. 4A-FIG. 9.

In step 302 (FIG. 3A), the MtM process is started. In step 304, the processing environment is set, and initial values are assigned to process variables. In step 306, the names of a set of network elements are extracted from a database. Herein, the name of a network element refers to a unique identifier, such as an IP address or alias name, for the network element. Basic data communication between the network monitor server and network elements in the set is tested with an IP ping. Note that a network monitor and a network monitoring agent are not required for a ping test. A ping test, for example, is included in an operating system such as Windows or Unix. In some instances, the functional state of a network monitoring agent is determined only for a subset of the network elements. For example, some network elements may not support network monitoring agents, or may not have network monitoring agents loaded on them.

In step 312, the network monitor server sends an IP ping to each network element in the set. In step 314, if the network monitor server receives a reply from the network element, in step 322, the name of the network element is written to a file for later processing. In step 314, if the network monitor server does not receive a reply from the network element, in step 316, after a specified retransmission interval, the network monitor server sends a second ping. In step 318, if the network monitor server receives a reply to the second ping, the name of the network element is written to the file in step 322. In step 318, if the network monitor server does not receive a reply to the second ping, in step 320, an error message is issued. To minimize the need for manual intervention, the network monitor performs a second ping test if the first ping test fails. If the second ping test fails, an error message is issued. The MtM process may be configured to permit more than two failed ping tests before issuing an error message.

Some network elements (for example, those which are less critical, or those which do not support a network monitoring agent) are tested only with a ping. In step 324, if the network element does not have a network monitoring (NM) agent loaded on it, in step 326, further checking is stopped. In step 324, if a network monitoring agent is loaded on the network element, the process passes to step 328 (FIG. 38). In step 328, the network monitor sends a query to the network monitoring agent residing on the network element. The query requests the network monitoring agent to report its functional state. At this phase in the MtM process, the functional state of the network monitoring agent is operational if it is running; otherwise, non-operational. In step 330, if the network monitor receives a reply from the network monitoring agent, in step 354, the network monitor sends a command to the network monitoring agent to execute a ST.

In step 330, if the network monitor does not receive a reply, in step 332, after a specified retransmission interval, the network monitor sends a second query to the network monitoring agent. In step 334, if the network monitor receives a reply to the second query, the process passes to step 354. In step 334, if the network monitor does not receive a reply, in step 336, the network monitor checks whether event agent (EA) software element is active. Event agent software provides Transmission Control Protocol (TCP)-level communications between the network monitor server and a network element. Event agent software permits the network monitor server to issue remote commands to a network element. One command allows the network monitor to restart (or, at least, attempt to restart) a network monitoring agent which is not running. If, in step 336, the event agent software element is not active, in step 338, the network monitor issues an error message. If, in step 336, the event agent software element is active, in step 340, the network monitor issues a command to attempt to restart the network monitoring agent. After a specified delay interval, in step 342, the network monitor sends a query to the network monitoring agent. In step 344, if the network monitor receives a reply, the process passes to step 354. In step 344, if the network monitor does not receive a reply, in step 346, the network monitor issues a second command to attempt to restart the network monitoring agent.

After a specified delay interval, in step 348, the network monitor sends a query to the network monitoring agent. If, in step 350, the network monitor does not receive a reply, in step 352, an error message is issued. In step 350, if the network monitor does receive a reply, the process passes to step 354. In step 354, the network monitor sends a command for the network monitoring agent to perform a ST. In step 356, if the network monitoring agent does not pass the ST, in step 360, an error message is issued, and the results of the ST are sent in a reply to the network monitor. If, in step 356, the network monitoring agent does pass the ST, the successful result is logged, and the results of the ST are sent in a reply to the network monitor in step 358. In another embodiment, in step 356, if the network monitoring agent does not pass the ST, the network monitor may send a second command for the network monitoring agent to execute a ST again. If the network monitoring agent does not pass the second ST, an error message is logged, and the results of the ST are sent in a reply to the network monitor. In general, if any process or test fails, the process or test may be repeated. An error message may be issued if the number of failures exceeds a threshold number, which is specified by the network administrator. Performing multiple attempts reduces the need for manual intervention.

For failed network monitoring agents, log files and error messages are saved for later analysis. Step 312-step 360 are iterated for every network element extracted in step 306. The entire MtM process (step 302-step 360) is autonomously iterated at specified times (for example, every 15 minutes).

The preceding steps describe one embodiment of the invention. Other embodiments may comprise alternative or additional steps. For example, a network monitor may be able to bypass a network monitoring agent and directly access MIBs or applications on a network element. In one embodiment, if the network monitor does not receive a reply to a query, or, if the network monitoring agent does not pass a ST, the MtM process may include steps for the network monitor to autonomously bypass the non-operational network monitoring agent and directly access MIBs or applications. This would be advantageous when the network elements are critical, since there is a redundant monitoring process which can be used until the non-operational network monitoring agent is diagnosed and restarted.

One implementation of an MtM process is built on a base commercial network package, the Computer Associates (CA) Unicenter Network and Systems Management, referred to herein as “Unicenter”. Software is written as a Perl script using Microsoft Windows and Unicenter command sets. The Perl script may be executed in an interpreted mode under control of the CMD Command Prompt in Microsoft Windows. In an advantageous embodiment, to provide additional reliability, the Perl script may be compiled into an executable process which is monitored by a system agent (discussed below). If the network monitor goes down, the system agent will detect it and issue an alert. Additional logic within the system agent may attempt to restart the network monitor. The system agent may also attempt to restart the entire MtM process. FIG. 4A-FIG. 9 are detailed flowcharts of this implementation of the MtM process.

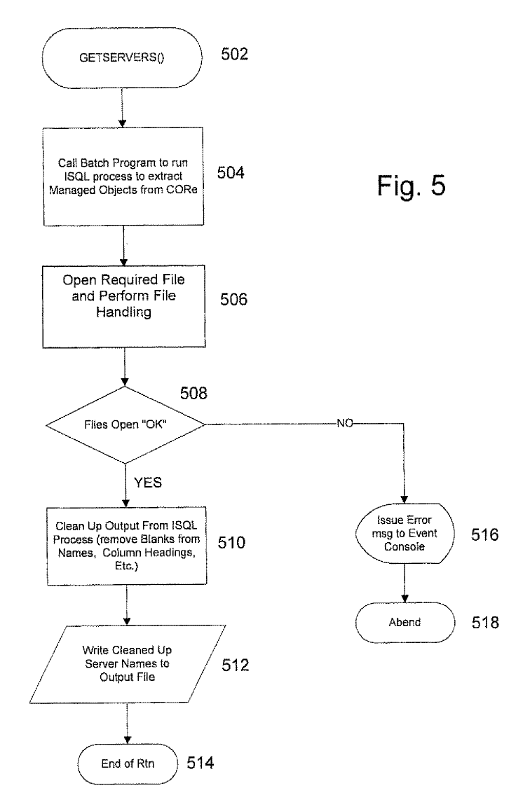

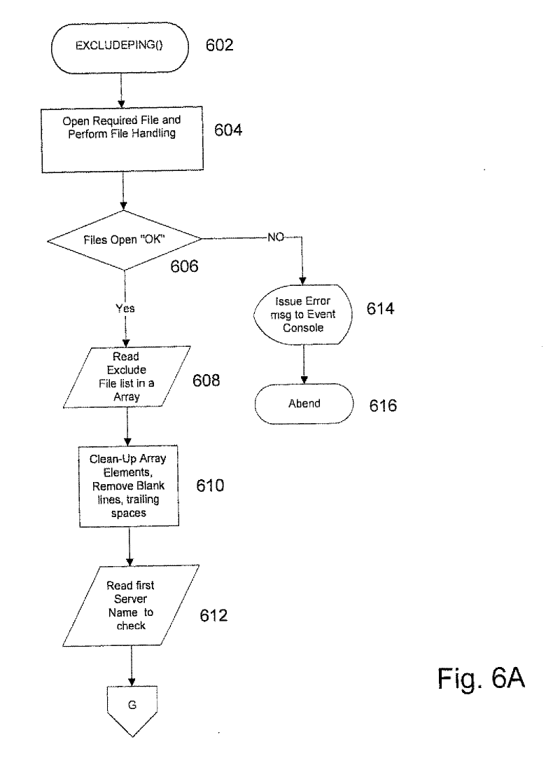

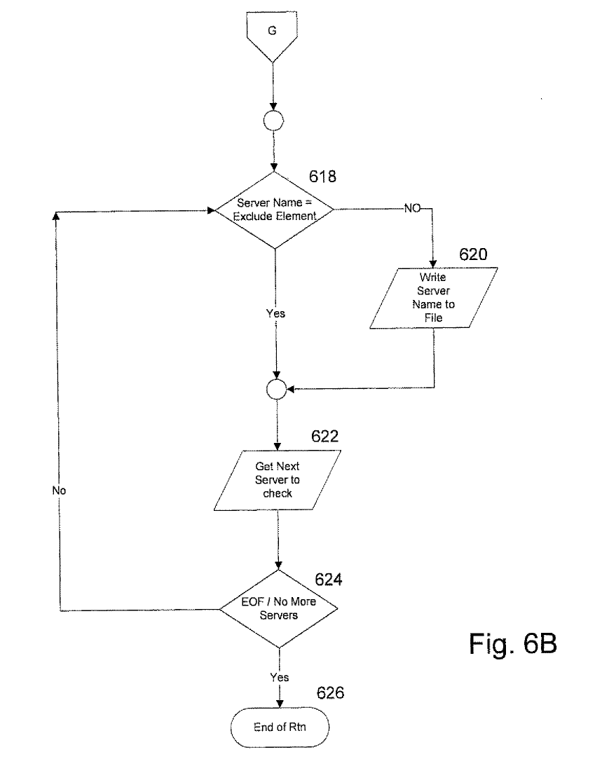

In FIG. 4A, the MtM process starts in step 402. In step 404, initial housekeeping functions are performed by the network monitor. The running environment and initial variable values are set, and startup messages are issued. In step 406, a loop start message is written to an event console. Further details of the event console are discussed below. In step 408, the network monitor executes the GETSERVERS( ) routine. In this routine, the network monitor gets a list of servers in the network of interest. In general, the list contains the names of network elements. In this example, the network elements are referred to as servers. Details of the GETSERVERS( ) routine are discussed further below in FIG. 5. Depending on the system architecture and network administration policies, some of the servers in the list may not be scheduled to be checked for proper operation. For example, some servers may be down for maintenance. These servers would not be checked. In step 410, the network monitor executes the EXCLUDEPING( ) routine. In this routine, the network monitor identifies the specific servers to be excluded from checks for proper operation. Details of the EXCLUDEPING( ) routine are discussed further below in FIG. 6A and FIG. 6B. The servers to be checked for proper operation shall be referred to herein as the servers of interest.

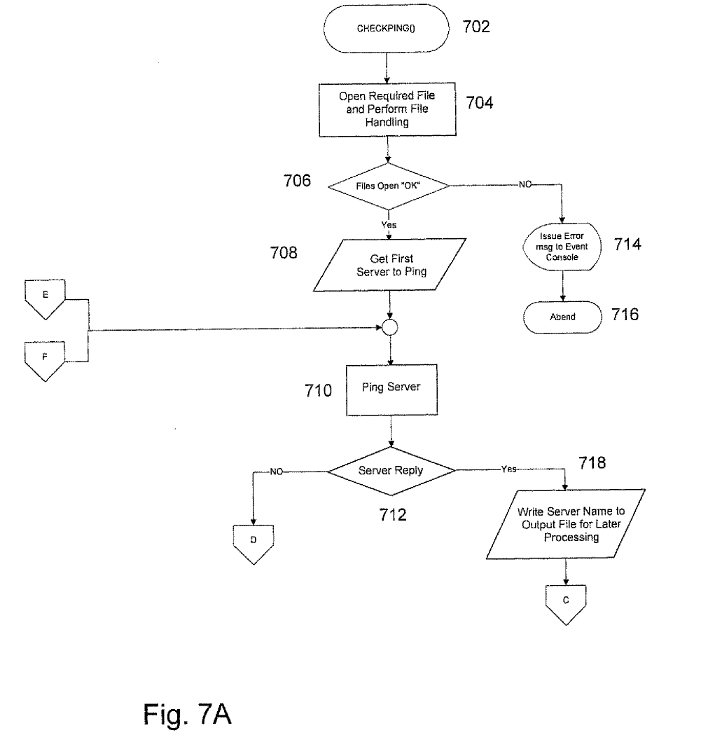

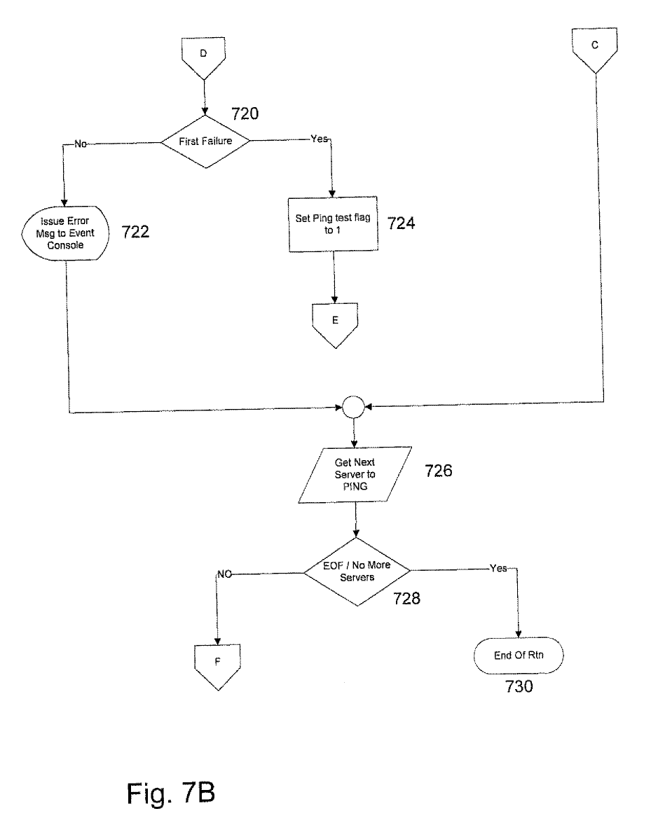

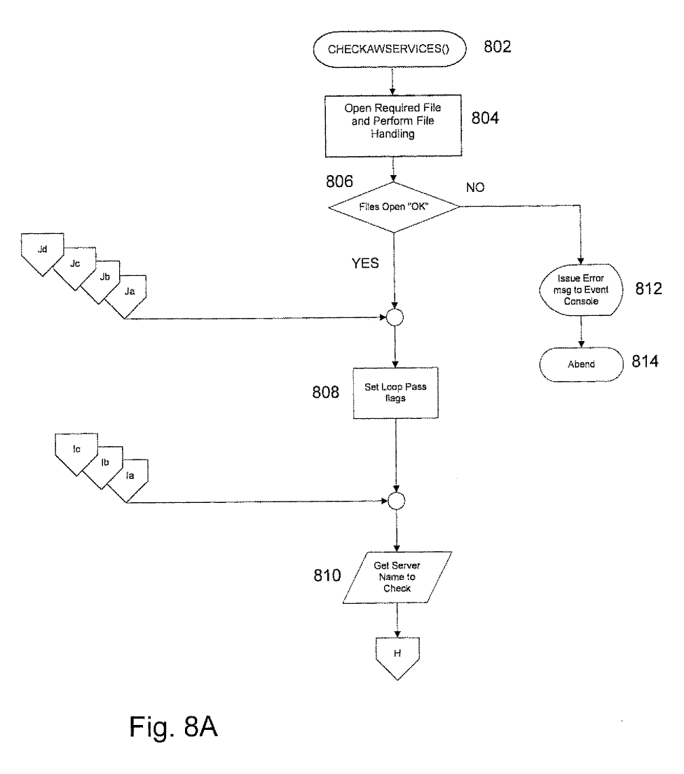

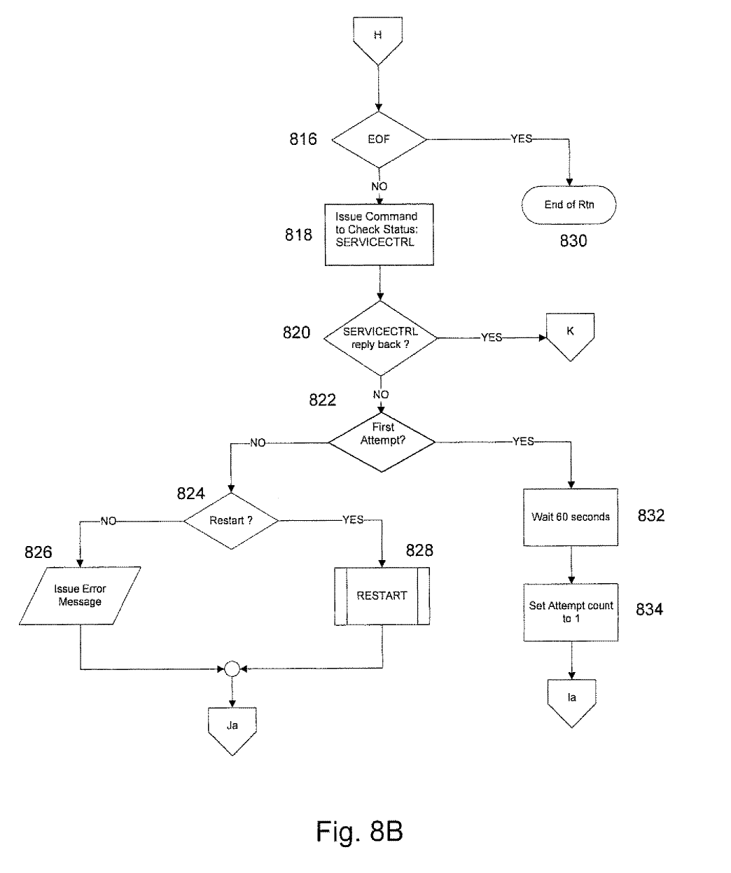

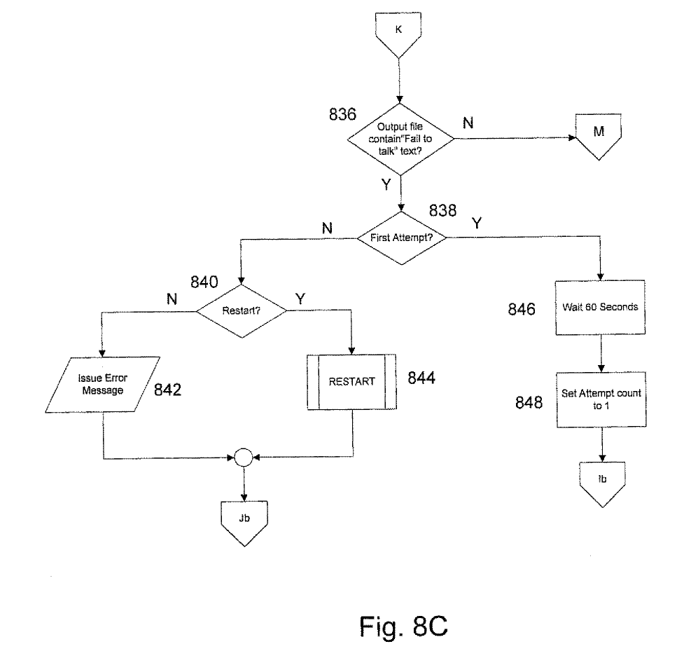

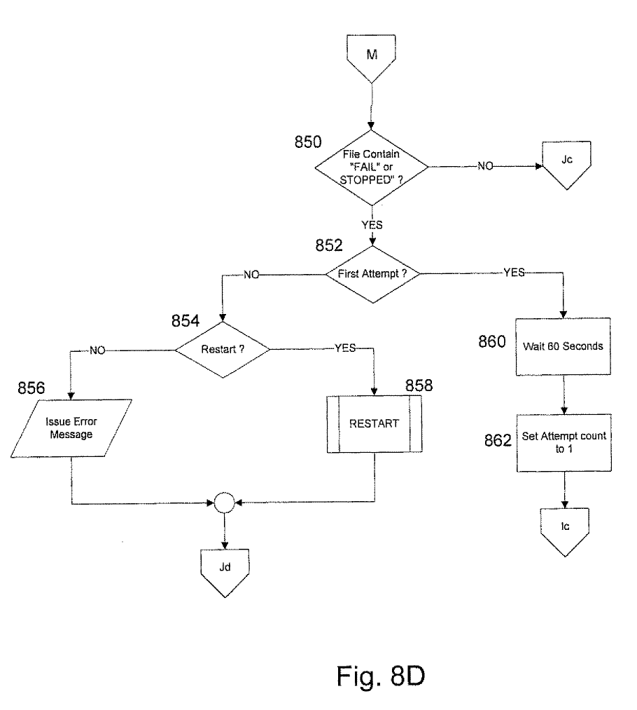

In step 412 (FIG. 4B), the network monitor executes the CHECKPING( ) routine. In this routine, the network monitor sends an IP ping message to each server of interest to check basic IP connectivity between the network monitor and the server of interest. Details of the CHECKPING( ) routine are discussed further below in FIG. 7A and FIG. 7B. In step 414, for each server of interest which passes the ping test and which has a network monitoring agent loaded onto it, the network monitor executes the CHECKAWSERVICES( ) routine. In this routine, the network monitor tests the proper operation of the network monitoring agents. Details of the CHECKAWSERVICES( ) routine are discussed further below in FIGS. 8A-8D. In step 416, the network monitor issues an end of pass message to the event console. The event console is a computer console on which messages (for example, those generated by servers, applications, network monitor, and MtM) are written and viewable by the network administrator. In step 418, the network monitor performs end of loop processing, updates the counters, and sleeps for a specified interval of time. After step 418, the process loops back to step 406 (FIG. 4A).

Details of individual routines are now described below.

Details of the GETSERVERS( ) routine are shown in the flowchart in FIG. 5. In step 502, the routine is started. In step 504, a batch program is called to run a process (called the ISQL process) to extract a list of managed objects from CORe. In this instance, the managed objects refer to the servers of interest. CORe (Common Object Repository) is a Unicenter SQL database. In general, the database may contain servers which are not managed objects. For example, some servers may be down for maintenance. The ISQL process extracts only managed objects to avoid generating alerts from the servers which are down for maintenance. In step 506, the required file is opened, and appropriate file handling is performed. In step 508, the file is checked for proper opening. If the file does not open properly, in step 516, an error message is issued to the event console, and, in step 518, the process abends. If, in step 508, the file does open properly, in step 510, the output from the ISQL process is cleaned-up. For example, blanks are removed from names and column headings. In step 512, the cleaned-up server names are written to an output file, and, in step 514, the routine ends.

Details of the EXCLUDEPING( ) routine are shown in the flowchart in FIG. 6A and FIG. 68. In step 602, the routine is started. In step 604, the required file is opened, and appropriate file handling is performed. In step 606, the file is checked for proper opening. If the file does not open properly, in step 614, an error message is issued to the event console, and the process abends in step 616. If, in step 606, the file does open properly, in step 608, the exclude list is read from an array in the file. In step 610, the array elements are cleaned up. For example, blank lines and trailing spaces are removed. In step 612, the name of the first server of interest to check is read. The process passes to step 618 (FIG. 6B). If the server name is not in the exclude element list, in step 620, the server name is written to another file for later processing, and the process passes to step 622. If, in step 618, the server name is in the exclude element list, the process passes directly to step 622. In step 622, the name of the next server of interest is retrieved from the list. In step 624, step 618-step 622 are iterated until servers on the list have been processed, that is, the end of file (EOF) is reached. The routine ends in step 626.

Details of the CHECKPING( ) routine are shown in the flowchart in FIG. 7A and FIG. 7B. In step 702, the routine is started. In step 704, the required file is opened, and appropriate file handling is performed. In step 706, the file is checked for proper opening. If the file does not open properly, in step 714, an error message is issued to the event console, and, in step 716, the process abends. If, in step 706, the file does open properly, in step 708, the name of the first server of interest in the file is retrieved. In step 710, the network monitor sends a ping to the server of interest. In step 712, if the server of interest replies to the ping, in step 718, the name of the server is written to an output file for later processing. The process passes to step 726 (FIG. 7B), in which the name of the next server in the file is retrieved. If, in step 728, there is a remaining server (which has not been pinged) in the file, the process loops back to step 710. After the servers in the file have been pinged (EOF has been reached) in step 730, the routine ends. Returning to step 712 (FIG. 7A), if the server does not reply to the ping, the process passes to step 720 (FIG. 7B). If this was the first ping that failed, in step 724, a ping test flag is set to 1. The process loops back to step 710, and the ping is transmitted a second time. In step 720, if this was the second ping (as indicated by the value of the ping flag) that failed, in step 722, an error message is issued to the event console.

Details of the CHECKAWSERVICES( ) routine are shown in the flowchart in FIG. 8A-FIG. 8D. AWSERVICES is an overall service for monitoring network functions. It comprises four components. The first component aws_orb, provides User Datagram Protocol (UDP)-level data transport for communication between the other three components discussed below, the MtM process, and the network monitor. The second component, Aws_sadmin, is an SNMP administrator. The third component, caiw2kos, is a UDP-level system agent, which monitors the operating system components. Operating system components include, for example, central processing unit (CPU) usage, available random access memory (RAM), page file utilization, disk drive usage, services, and processes (both server based and application based). The fourth component, cailoga2, reads ASCII text files for specific text strings (alphanumeric characters).

In step 802, the routine is started. In step 804, the required file is opened, and appropriate file handling procedures are performed. In step 806, the file is checked for proper opening. If the file does not open properly, in step 812, an error message is issued to the event console, and the process abends in step 814. If, in step 806, the file does open properly, in step 808, loop flags are set. In step 810, a name of a server of interest is retrieved to check. The process passes to step 816 (FIG. 8B). If the names have been processed (end of file has been reached), the routine ends in step 830. If, in step 816, there are remaining servers to process, in step 818, the servicectrl command is issued to check status of the server. Status here refers to whether all four components in AWSERVICES (as discussed above) above are running. The output of the servicectrl command is written to an output file for further processing. In step 820, the network monitor waits for a reply back from the server. If the server does reply, the process passes to step 836 (FIG. 8C).

In step 836, the output file is checked for “Fail to Talk” text. “Fail to Talk” is one of the possible responses to the servicectrl command. In most instances, this response is generated either when all four components in AWSERVICES are down, or when there is no communication between the network monitor and the network monitoring agent. If it does not contain “Fail to Talk” text, the process passes to step 850 (FIG. 8D). In step 850, the output file is checked for “FAILED” and “STOPPED” conditions. “FAILED” and “STOPPED” refer to the status of the individual components of AWSERVICES. A component may be in a STOPPED status as a result of an explicit stop command. A component may be in a FAILED status as a result of an error condition. An example of the output of a servicectrl command is the following:

RUNNING aws_orb

RUNNING aws_sysadmin

STOPPED caiw2kos

FAILED cailoga2.

If it does not contain one of these conditions (STOPPED or FAILED), the process loops back to step 808 (FIG. 8A). If the output file does contain one of the conditions, the process passes to step 852. In this step, the number of attempts is checked. If this was the first attempt (that is, the first time one of the conditions was encountered), the process passes to a wait period of 60 seconds in step 860. In step 862, the attempt count is set equal to 1, and the process loops back to step 810 (FIG. 8A).

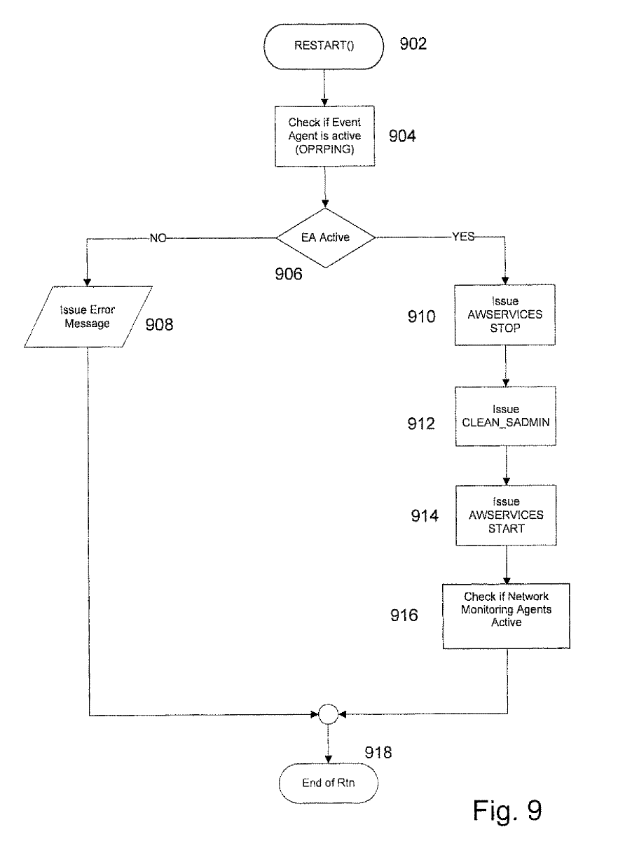

Returning to step 852 (FIG. 8D), if this was not the first attempt, the process passes to step 854, in which, according to network policy, a decision is made whether to restart the network monitoring agent. If a restart is not issued, in step 856, an error message is issued, and the process loops back to step 808 (FIG. 8A). If, in step 854, a decision to restart the network monitoring agent is made, the process passes to the RESTART( ) routine in step 858, details of which are described later in the flowchart in FIG. 9. The process loops back to step 808.

Returning to step 838 (FIG. 8C), if it is not the first attempt, the process passes to step 840, in which, according to network policy, a decision is made whether to restart the network monitoring agent. If a restart is not issued, in step 842, an error message is issued, and the process loops back to step 808. If, in step 840, a decision to restart the network monitoring agent is made, the process passes to the RESTART( ) routine in step 844, details of which are described later in the flowchart in FIG. 9. The process loops back to step 808.

Returning to step 820 (FIG. 8B), if there is no reply to the servicectrl command, the process passes to step 822, in which the number of attempts is checked. If it is the first attempt (that is, the first time in which there was no reply), the process passes to step 832 and waits for 60 seconds. In step 834, the attempt count is set to 1, and the process loops back to step 810. If, in step 822, it is not the first attempt, the process passes to step 824, in which, according to network policy, a decision is made whether to restart the network monitoring agent. If a restart is not issued, in step 826, an error message is issued, and the process loops back to step 808. If, in step 824, a decision to restart the network monitoring agent is made, the process passes to the RESTART( ) routine in step 828, details of which are described later in the flowchart in FIG. 9. The process loops back to step 808.

Details of the RESTART( ) routine are shown in the flowchart in FIG. 9. In step 902, the routine is started. In step 904, the event agent is checked to see whether it is active. The event agent provides TCP-level communications between servers. Various implementations of event agents are available. In the embodiment shown, the Unicenter Event Agent is used. The Unicenter Event Agent is an add-on service that captures and reacts to Windows Event Messages (System, Application, Security). These messages can be forwarded to a Unicenter Manager (Network Manager) for processing, can be acted upon on the local application server, or just ignored. A component of the Unicenter Event Agent included is CCI, an enhanced TCP from CA (Computer Associates). CCI allows two way communications between two servers, basically a user on one system (workstation or server) can route a command for execution to another server. In step 904, the network monitor sends an OPRPING command to the network monitoring agent. If the network monitor receives a reply, the CCI is installed; otherwise, not.

In step 906, if the event agent is not active, in step 908, an error message is issued, and the routine ends in step 918. If, in step 906, the event agent is active, an attempt is made to restart the network monitoring agent, using the following sequence of commands. In step 910, an AWSERVICES STOP command is issued to stop the AWSERVICES process. In step 912, a CLEAN-SADMIN command is issued. This command cleans up corruptions that may have resulted when AWSERVICES or a network monitoring agent crashed. In step 914, an AWSERVICES START command is issued to restart AWSERVICES. In step 916, the network monitoring agents are checked to see whether they are active. In the embodiment shown, the servicectrl command is reissued. Receipt of a reply is checked. If there is a reply, the presence of FAILED or STOP within the reply is checked. If any fault condition (Fail to Talk, FAILED, STOPPED) occurs, an error message is issued, and the process continues. The routine ends in step 918.

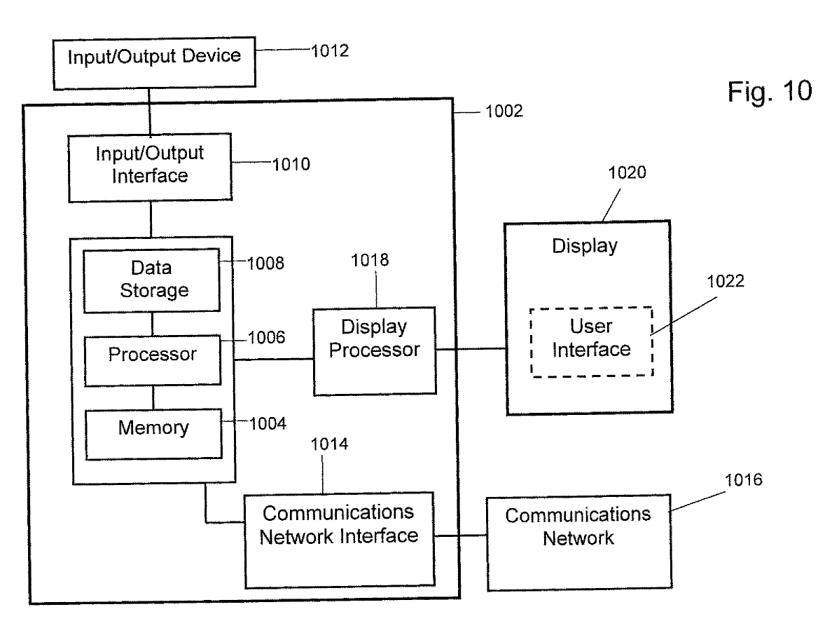

Different embodiments of a network monitor as shown in the functional block diagram in FIG. 2 may be implemented with different hardware and software. In one embodiment, a network monitor is implemented with a task-specific network monitor processor. In another embodiment, a network monitor is implemented using a computer. As shown in FIG. 10, computer 1002 may be any type of well-known computer comprising a processor 1006, memory 1004, data storage 1008, and input/output interface 1010. Processor 1006, for example, may be a central processing unit (CPU). Data storage 1008 may comprise a hard drive or non-volatile memory. Input/output interface 1010 may comprise a connection to an input/output device 1012, such as a keyboard or mouse. Computer 1002 may further comprise one or more network interfaces. For example, communications network interface 1014 may comprise a connection to an Internet Protocol (IP) communications network 1016, which may transport user traffic. Computer 1002 may further comprise a display processor 1018. A display processor or generator is a known element comprising electronic circuitry or software or a combination of both for generating display images or portions thereof. For example, display images or portions thereof may be generated on display 1020, which, for example, may be a cathode ray tube (CRT) display or a liquid crystal display (LCD). User interface 1022 comprises one or more display images enabling user interaction with a processor or other device and associated data acquisition and processing functions.

As is well known, a computer operates under control of computer software which defines the overall operation of the computer and executable applications. An executable application as used herein comprises code or machine-readable instruction, that is compiled or interpreted, for implementing predetermined functions including those of an operating system, healthcare information system, or other information processing system, for example, in response to user command or input. An executable procedure is a segment of code (machine-readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting, or transmitting information for use by an executable procedure or an information device, and/or by routing the information to an output device. A processor may use or comprise the capabilities of a controller or microprocessor, for example.

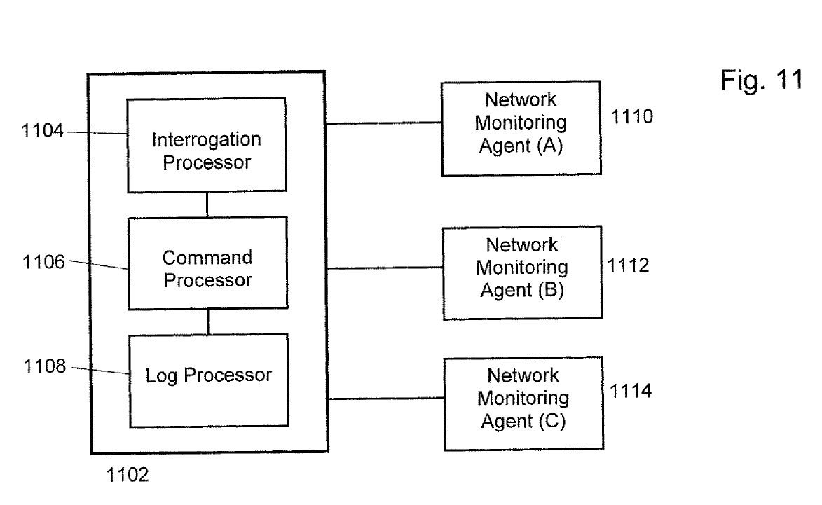

Another embodiment of a network monitor is a supervisory system, as shown in FIG. 11. Supervisory system 1102 comprises interrogation processor 1104, command processor 1106, and log processor 1108. Supervisory system 1102 communicates with a plurality of network monitoring agents. In the example shown in FIG. 11, there are three network monitoring agents: network monitoring agent A 1110, network monitoring agent B 1112, and network monitoring agent 1114. As discussed above, a network monitoring agent is a software element which resides on a network element and monitors parameters in the network element and associated software. Network elements may further be loaded with executable applications. Herein, a processing system comprises a set of executable applications and/or associated hardware for implementing predetermined functions including those of an operating system, healthcare information system, or other information processing system, for example, in response to user command or input. In a processing system, parameters of interest which may be monitored by a network monitoring agent include, for example, CPU usage, memory usage, number of input and output operations performed in a time interval, error events, and CPU interruptions.

Supervisory system 1102 comprises executable procedures for supervising operation of network monitoring agent A 1110, network monitoring agent B 1112, and network monitoring agent C 1114. The executable procedures comprise the following steps. Interrogation processor 1104 autonomously interrogates, at specified times, the status of network monitoring agent A 1110, network monitoring agent B 1112, and network monitoring agent C 114. Herein, interrogating the status of a network monitoring agent refers to sending a query to a network monitoring agent to determine its functional state. Interrogation processor 1104 further autonomously identifies the networking monitoring agents whose functional state is operational and the network monitoring agents whose functional state is non-operational. In the example shown in FIG. 11, the functional state of network monitoring agent A 1110 is non-operational, and the functional states of network monitoring agent B 1112 and network monitoring agent C 1114 are operational. In response to identification of the non-operational functional state of network monitoring agent A 1110, command processor 1106 may autonomously communicate a command to restart network monitoring agent A 1110. Log processor 1108 generates a record for storage. The record indicates that command processor 1106 autonomously communicated a command to restart network monitoring agent A 1110. The record further indicates the associated time and date at which the command was communicated. In one embodiment, if network monitoring agent A 1110 fails to restart, command processor 1106 communicates an alert message indicating that network monitoring agent A 1110 tailed to restart. An alert message, for example, may comprise an e-mail to a user such as a network administrator or technician.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operation of a network monitor for autonomously determining functional states of a plurality of network monitoring agents loaded on a plurality of network elements, comprising the steps of:
autonomously sending a plurality of queries to said plurality of network monitoring agents;
receiving a plurality of replies reporting the functional states of said network monitoring agents;
determining that the functional state of a network monitoring agent is non-operational if a reply is not received from said network monitoring agent within a timeout interval; and,
autonomously attempting to restart a non-operational network monitoring agent.

2. The method of claim 1 wherein said queries comprise commands for said network monitoring agents to perform self-tests.

3. The method of claim 2 wherein the functional state of a network monitoring agent is operational if said network monitoring agent passes said self-test.

4. The method of claim 2 wherein the functional state of a network monitoring agent is non-operational if said network monitoring agent does not pass said self-test.

5. The method of claim 1, further comprising the step of:
autonomously bypassing a non-operational network monitoring agent and directly accessing applications on a network element on which said non-operational network monitoring agent is loaded.

6. The method of claim 1 wherein said plurality of queries is autonomously sent by said network monitor at specified times.

7. A network monitor processor configured to:
autonomously send a plurality of queries to a plurality of network monitoring agents;
determine, from replies received from said network monitoring agents, functional states of said network monitoring agents;
measure a timeout interval;
determine whether a reply from a network monitoring agent in response to a query has been received within said timeout interval;
determine that the functional state of said network monitoring agent is non-operational if a reply is not received within said timeout interval; and,
autonomously attempt to restart a non-operational network monitoring agent.

8. A system for supervising operation of a plurality of network monitoring agents comprising executable procedures for monitoring operation of processing systems, comprising:
an interrogation processor for autonomously intermittently interrogating status of network monitoring agents comprising executable procedures for monitoring operation of processing systems and for identifying a non-operational network monitoring agent;
a command processor for, in response to identifying a non-operational network monitoring agent, autonomously communicating a command to restart said non-operational network monitoring agent; and,
a log processor for generating a record for storage indicating said autonomous communication of said command to restart said non-operational network monitoring agent and an associated time and date.

9. A system according to claim 8, wherein
said command processor, in response to a failure to restart said non-operational network monitoring agent, communicates an alert message to a user indicating said failure to restart said non-operational network monitoring agent.

10. A system according to claim 8, wherein
said executable procedures monitor operation of said processing systems by monitoring at least two of, (a) CPU usage, (b) memory usage, (c) number of input and output operations performed in a time interval, (d) error events, and (e) CPU interruptions.

11. A system for supervising operation of a plurality of network monitoring agents comprising executable procedures for monitoring operation of processing systems, comprising:
an interrogation processor for autonomously intermittently interrogating status of network monitoring agents comprising executable procedures for monitoring operation of processing systems and for identifying a non-operational network monitoring agent;
a command processor for, in response to identifying a non-operational network monitoring agent, autonomously communicating a command to restart said non-operational network monitoring agent and in response to a failure to restart said non-operational network monitoring agent, communicating an alert message to a user indicating said failure to restart said non-operational network monitoring agent; and,
a log processor for generating a record for storage indicating said autonomous communication of said command to restart said non-operational network monitoring agent and an associated time and date.

12. A computer readable medium storing executable instructions for operating a network monitor for autonomously determining functional states of a plurality of network monitoring agents loaded on a plurality of network elements, the executable instructions defining the steps of:
autonomously sending a plurality of queries to said plurality of network monitoring agents;
receiving a plurality of replies reporting the functional states of said network monitoring agents;
determining that the functional state of a network monitoring agent is non-operational if a reply is not received from said network monitoring agent within a timeout interval; and,
autonomously attempting to restart a non-operational network monitoring agent.

13. The computer readable medium of claim 12 wherein said executable instructions further comprise executable instructions defining the step of:
sending commands for said network monitoring agents to perform self-tests.

14. The computer readable medium of claim 12 wherein said executable instructions further comprise executable instructions defining the step of:
autonomously sending a plurality of queries to said plurality of network monitoring agents at specified times.
